(19) United States
(12) Patent Application Publication
(10) Pub. No.: US 2023/0006401 A1
(43) Pub. Date: Jan. 5, 2023

(54) Solar Powered Outlet Assembly

(71) Applicant: Misty Roby, Somerset, PA (US)

(72) Inventor: Misty Roby, Somerset, PA (US)

(21) Appl. No.: 17/363,184

(22) Filed: Jun. 30, 2021

(51) Int. Cl. H01R 13/66; H02S 10/40; H02S 20/10; H02S 40/30; H01R 25/00; H01R 13/10

(52) U.S. Cl. CPC H01R 13/6675; H02S 10/40; H02S 20/10; H02S 40/30; H01R 25/006; H01R 13/10

(57) ABSTRACT

A solar powered outlet assembly includes a housing that has a spike to penetrate a support surface thereby retaining the housing on the support surface. A pair of female electrical outlets is each integrated into the housing to have a male power cord plugged into the female electrical outlets. A solar panel is coupled to the housing such that the solar panel is exposed to sunlight. The solar panel is in electrical communication with each of the female electrical outlets. In this way the solar panel can supply electrical power to the male power cord that is plugged into the female electrical outlets.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to outlet devices and more particularly pertains to a new outlet device for supplying electrical power in a remote location. The device includes a housing, a pair of female electrical outlets integrated into the housing and a solar panel coupled to the housing. The device includes a power converter that is positioned in the housing for converting direct current produced by the solar panel into alternating current for the female electrical outlets.

### (2) Description of Related Art Including Information Disclosed Under 37 CFR 1.97 and 1.98

The prior art relates to outlet devices including a portable solar generator for supplying power for a stationary electronic device. The prior art discloses a charger device which includes a battery for charging an electronic device when no electrical power is available. The prior art discloses a variety of portable chargers that each includes a battery for supplying electrical power for an electronic device.

### BRIEF SUMMARY OF THE INVENTION

An embodiment of the disclosure meets the needs presented above by generally comprising a housing that has a spike to penetrate a support surface thereby retaining the housing on the support surface. A pair of female electrical outlets is each integrated into the housing to have a male power cord plugged into the female electrical outlets. A solar panel is coupled to the housing such that the solar panel is exposed to sunlight. The solar panel is in electrical communication with each of the female electrical outlets. In this way the solar panel can supply electrical power to the male power cord that is plugged into the female electrical outlets.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a solar powered outlet assembly according to an embodiment of the disclosure.

FIG. 2 is a back perspective view of an embodiment of the disclosure.

FIG. 3 is a right side phantom view of an embodiment of the disclosure.

FIG. 4 is a perspective in-use view of an embodiment of the disclosure.

### DETAILED DESCRIPTION OF THE INVENTION

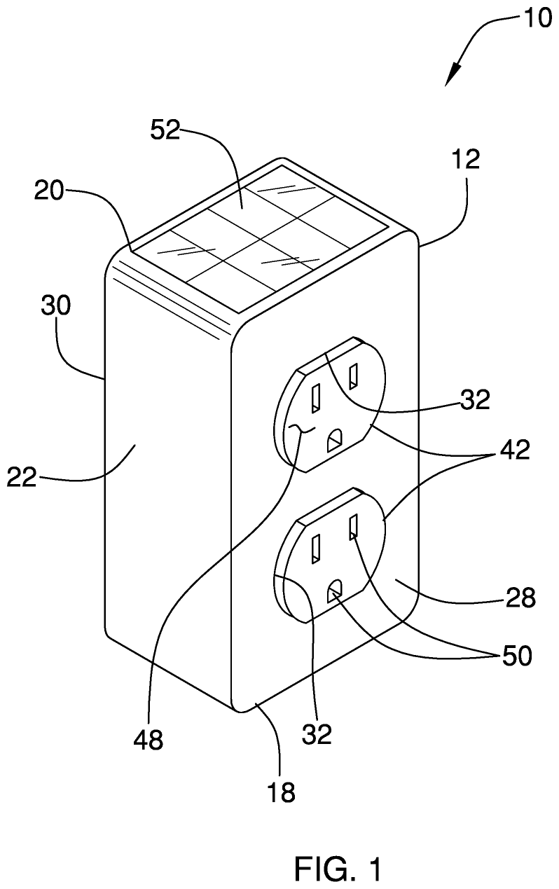

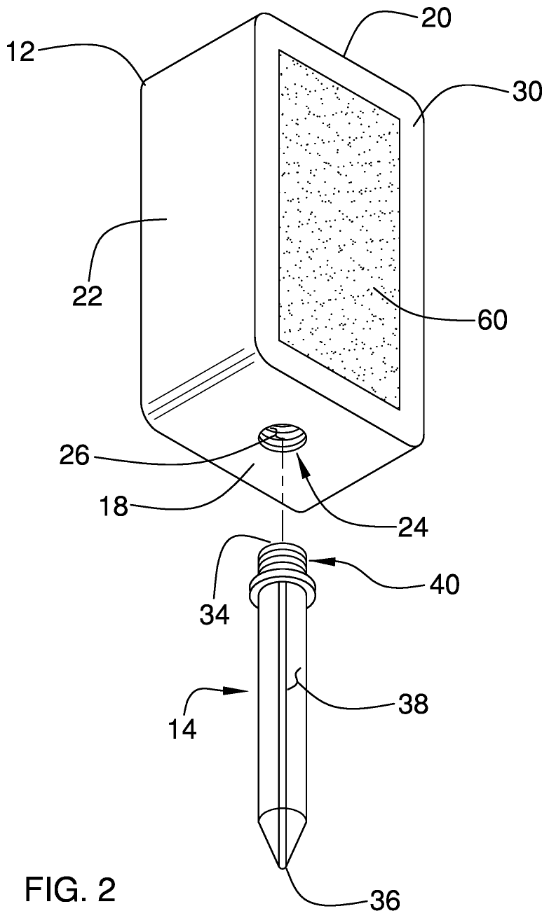

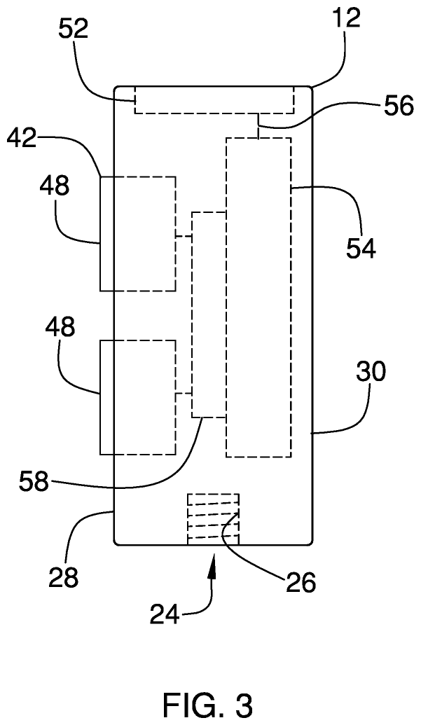

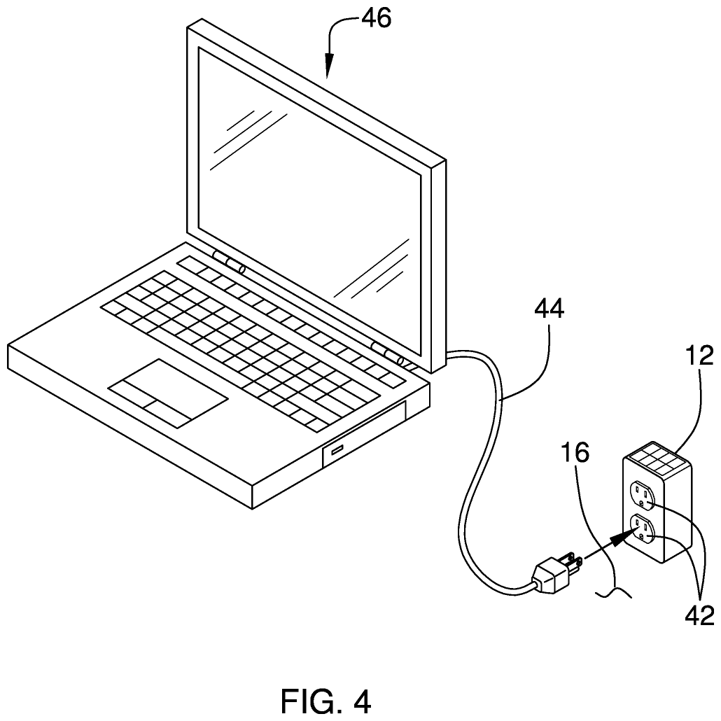

With reference now to the drawings, and in particular to FIGS. 1 through 4 thereof, a new outlet device embodying the principles and concepts of an embodiment of the disclosure and generally designated by the reference numeral 10 will be described.

As best illustrated in FIGS. 1 through 4, the solar powered outlet assembly 10 generally comprises a housing 12 that has a spike 14 extending downwardly from the housing 12. The spike 14 can penetrate a support surface 16 thereby retaining the housing 12 on the support surface 16. The support surface 16 may be the ground or other horizontal support surface. The housing 12 has a bottom wall 18, a top wall 20 and an outer wall 22 extending between the top wall 20 and the bottom wall 18, and the bottom wall 18 has a well 24 extending upwardly toward the top wall 20. The well 24 has a bounding surface 26 and the bounding surface 26 is threaded. The outer wall 22 has a front side 28 and a back side 30, and the front side 28 has a pair of outlet openings 32 each extending into an interior of the housing 12. The outlet openings 32 are spaced apart from each other and are distributed between the bottom wall 18 and the top wall 20.

The spike 14 has a top end 34 and a bottom end 36, and the spike 14 tapers to a point between the top end 34 and the bottom end 36, and an outer surface 38 of the spike 14 has a threaded portion 40 located adjacent to the top end 34. The well 24 in the bottom wall 18 of the housing 12 insertably receives the top end 34. Additionally, the threaded portion 40 threadably engages the bounding surface 26 of the well 24 for attaching the spike 14 to the housing 12. The spike 14 may have a length ranging between approximately 3.0 inches and 5.0 inches.

A pair of female electrical outlets 42 is provided and each of the female electrical outlets 42 is integrated into the housing 12 to have a male power cord 44 plugged into the female electrical outlets 42. The male power cord 44 may be a power cord of an electronic device 46 that requires alternating current to function. Each of the female electrical outlets 42 extends through a respective one of the outlet openings 32 in the front side 28 of the outer wall 22 of the housing 12. Additionally, each of the female electrical outlets 42 has an exposed surface 48 with respect to the front side 28. The exposed surface 48 of each of the female electrical outlets 42 has a plurality of ports 50 each is recessed into the exposed surface 48 to insertably receive a respective contact 51 on the male power cord 44. Additionally, each of the female electrical outlets 42 may include electrical contacts that are positioned in each of the ports 50 and connection points that are located inside of the housing 12.

A solar panel 52 is coupled to the top wall 20 of the housing 12 such that the solar panel 52 is exposed on the housing 12 such that the solar panel 52 is exposed to sunlight. The solar panel 52 is in electrical communication with each of the female electrical outlets 42 to supply electrical power to the male power cord 44 that is plugged into the female electrical outlets 42. Thus, the solar panel 52 facilitates the female electrical outlets 42 to supply electrical power in a remote location. A power converter 54 is integrated into the housing 12 and the power converter 54 has an input 56 and an output 58. The solar panel 52 is electrically coupled to the input 56 and the output 58 is in communication with each of the female electrical outlets 42. The power converter 54 converts direct current produced by the solar panel 52 into alternating current supplied to the female electrical outlets 42. Moreover, the power converter 54 may comprise an electronic power converter that has sufficient capacity to produce approximately 120.0 volts of alternating current.

A mating member 60 is coupled to the back side 30 of the outer wall 22 of the housing 12 to engage a support surface 16 for retaining the housing 12 on the support surface 16. The mating member 60 may comprise an adhesive strip to adhesively engage the support surface 62. The support surface 16 may be a wall, for example, or other type of vertical support surface. The mating member 60 may include a protective sheet that is removable from the mating member 60 prior to adhering the mating member 60 to the support surface 62.

In use, the housing 12 is positioned in a desired location outdoors and either the mating member 60 is mated to the vertical support surface 16, or the spike 14 is attached to the housing 12 and the spike 14 is urged into the horizontal support surface 16. In this way the solar panel 52 is exposed to sunlight and each of the female electrical outlets 42 supplies electrical power for the male power cord 44. In this way an electronic device 46 that requires alternating current can be employed in a location that does not have electrical power.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A solar powered outlet assembly for supplying alternating current from solar power, said assembly comprising:
a housing having a spike extending downwardly from said housing wherein said spike is configured to penetrate a support surface thereby retaining said housing on the support surface;
a pair of female electrical outlets, each of said female electrical outlets being integrated into said housing wherein each of said female electrical outlets is configured to have a male power cord plugged into said female electrical outlets; and
a solar panel being coupled to said housing such that said solar panel is exposed on said housing wherein said solar panel is configured to be exposed to sunlight, said solar panel being in electrical communication with each of said female electrical outlets wherein said solar panel is configured to supply electrical power to the male power cord that is plugged into said female electrical outlets.

2. The assembly according to claim 1, wherein:
said housing having a bottom wall, a top wall and an outer wall extending between said top wall and said bottom wall, said bottom wall having a well extending upwardly toward said top wall, said well having a bounding surface, said bounding surface being threaded, said outer wall having a front side and a back side, said front side having a pair of outlet openings each extending into an interior of said housing, said outlet openings being spaced apart from each other and being distributed between said bottom wall and said top wall; and
each of said female electrical outlets extends through a respective one of said outlet openings in said front side of said outer wall of said housing, each of said female electrical outlets having an exposed surface with respect to said front side, said exposed surface of each of said female electrical outlets having a plurality of ports each being recessed into said exposed surface wherein each of said ports is configured to insertably receive a respective contact on the male power cord.

3. The assembly according to claim 2, wherein said spike has a top end and a bottom end, said spike tapering to a point between said top end and said bottom end, an outer surface of said spike having a threaded portion located adjacent to said top end, said well in said bottom wall of said housing insertably receiving said top end having said threaded portion threadably engaging said bounding surface of said well for attaching said spike to said housing.

4. The assembly according to claim 1, wherein:
said solar panel is positioned on a top wall of said housing;
said assembly includes a power converter being integrated into said housing, said power converter having an input and an output, said solar panel being electrically coupled to said input, said output being in communication with each of said female electrical outlets, said power converter converting direct current produced by said solar panel into alternating current supplied to said female electrical outlets.

5. The assembly according to claim 2, further comprising a mating member being coupled to said back side of said outer wall of said housing wherein said mating member is configured to engage a support surface for retaining said housing on the support surface.

6. A solar powered outlet assembly for supplying alternating current from solar power, said assembly comprising:
a housing having a spike extending downwardly from said housing wherein said spike is configured to penetrate a support surface thereby retaining said housing on the support surface, said housing having a bottom wall, a top wall and an outer wall extending between said top wall and said bottom wall, said bottom wall having a well extending upwardly toward said top wall, said well having a bounding surface, said bounding surface being threaded, said outer wall having a front side and a back side, said front side having a pair of outlet openings each extending into an interior of said housing, said outlet openings being spaced apart from each other and being distributed between said bottom wall and said top wall;
said spike having a top end and a bottom end, said spike tapering to a point between said top end and said bottom end, an outer surface of said spike having a threaded portion located adjacent to said top end, said well in said bottom wall of said housing insertably receiving said top end having said threaded portion threadably engaging said bounding surface of said well for attaching said spike to said housing;
a pair of female electrical outlets, each of said female electrical outlets being integrated into said housing wherein each of said female electrical outlets is configured to have a male power cord plugged into said female electrical outlets, each of said female electrical outlets extending through a respective one of said outlet openings in said front side of said outer wall of said housing, each of said female electrical outlets having an exposed surface with respect to said front side, said exposed surface of each of said female electrical outlets having a plurality of ports each being recessed into said exposed surface wherein each of said ports is configured to insertably receive a respective contact on the male power cord;
a solar panel being coupled to said housing such that said solar panel is exposed on said housing wherein said solar panel is configured to be exposed to sunlight, said solar panel being in electrical communication with each of said female electrical outlets wherein said solar panel is configured to supply electrical power to the male power cord that is plugged into said female electrical outlets, said solar panel being positioned on said top wall of said housing;
a power converter being integrated into said housing, said power converter having an input and an output, said solar panel being electrically coupled to said input, said output being in communication with each of said female electrical outlets, said power converter converting direct current produced by said solar panel into alternating current supplied to said female electrical outlets; and
a mating member being coupled to said back side of said outer wall of said housing wherein said mating member is configured to engage a support surface for retaining said housing on the support surface.
